(19) United States
(12) Patent Application Publication
(10) Pub. No.: US 2016/0042220 A1
(43) Pub. Date: Feb. 11, 2016

(54) TERMINAL DEVICE AND INFORMATION PROCESSING METHOD

(71) Applicants: BEIJING LENOVO SOFTWARE LTD., Beijing (CN); LENOVO (BEIJING) LIMITED, Beijing (CN)

(72) Inventor: TONGBIN JU, BEIJING (CN)

(21) Appl. No.: 14/658,937

(22) Filed: Mar. 16, 2015

(30) Foreign Application Priority Data
Aug. 7, 2014 (CN) 201220444487.8
Aug. 7, 2014 (CN) 201420444479.3
Aug. 14, 2014 (CN) 201410400131.9

(51) Int. Cl. G06K 9/00; G06F 3/0484

(52) U.S. Cl. CPC G06K 9/00013; G06F 3/04842; G06F 3/04847; G06K 9/00087

(57) ABSTRACT

The present disclosure provides a terminal device comprising: a housing and a fingerprint recognition unit, the housing having an accommodating space formed therein, and comprising a front surface, a rear surface, and a side which connects the front surface to the rear surface, and the fingerprint recognition unit comprising: a fingerprint recognition module and a fingerprint collection part, wherein the fingerprint recognition module is connected to the fingerprint collection part, the fingerprint collection part is configured to collect a fingerprint, and the fingerprint recognition module is configured to recognize the fingerprint collected by the fingerprint collection part, wherein the fingerprint recognition module is arranged in the accommodating space and the fingerprint collection part is arranged on the side. The present disclosure further provides an information processing method and a terminal device, to enable a user to operate the terminal device through a fingerprint.

### CROSS-REFERENCE TO RELATED APPLICATION(S)

This application claims priority to the Chinese Patent Application No. 201420444479.3, filed on Aug. 7, 2014, entitled “TERMINAL DEVICE AND INFORMATION PROCESSING METHOD”, the Chinese Patent Application No. 201420444487.8, filed on Aug. 7, 2014, entitled “TERMINAL DEVICE AND INFORMATION PROCESSING METHOD” and the Chinese Patent Application No. 201410400131.9, filed on Aug. 14, 2014, entitled “TERMINAL DEVICE AND INFORMATION PROCESSING METHOD,” which are incorporated herein by reference in their entireties.

### TECHNICAL FIELD

The present disclosure relates to the field of computer technology, and in particular, to a terminal device and an information processing method.

### BACKGROUND

Fingerprints are streaklines resulting from the rugged skin on the front of a person's finger tip. The streaklines are arranged regularly to form different patterns of fingerprints. The start points, end points, joint points, and bifurcation points of the streaklines are referred to as detail feature points of the fingerprints. Different fingerprints can be distinguished by comparing different detail feature points of the fingerprints. As different persons have different fingerprints, and even for the same person, he/she has distinctly different fingerprints on ten fingers, the fingerprints can be used for personal identification.

In the prior art, a digital password lock is generally used in a terminal device such as a mobile phone, a tablet or the like, i.e., a digital password needs to be input before the mobile phone or the tablet is started up, and if the password matches, the mobile phone or the tablet can be unlocked.

In the process of implementing the above technical solution, there is a problem that if a digital password set by a user for the terminal device (such as a mobile phone or a tablet or the like) is very complex, the password is easy to forget; and if the digital password set by the user is very simple, the password is easy to be cracked, thereby reducing the security of the terminal device.

With the screen of the mobile phone becoming larger, a distance between the left and right sides of the mobile phone also increases. In some cases, if a user uses a phone with his/her right hand while placing his/her left hand on a handrail in a subway, or if a user takes out a mobile phone with his/her right hand and checks the weather with the mobile phone in his/her right hand after shopping with a shopping bag in his/her left hand, it is very inconvenient to operate and control an object on the left of the display screen of the mobile phone. Therefore, there is a technical problem that it is inconvenient to operate a terminal device with a single hand.

### SUMMARY

In view of this, the present disclosure provides a terminal device, which improves user experience compared with a terminal device that uses digital encryption. In addition, the present disclosure provides a terminal device and an information processing method, which improves the user experience to enable a user to operate a terminal device with a single hand.

In an aspect, embodiments of the present disclosure provide a terminal device, comprising: a housing having an accommodating space formed therein, the housing comprising a front surface, a rear surface, and a side which connects the front surface to the rear surface, wherein the terminal device further comprises a fingerprint recognition unit comprising: a fingerprint recognition module and a fingerprint collection part, wherein the fingerprint recognition module is connected to the fingerprint collection part, the fingerprint collection part is configured to collect a fingerprint, and the fingerprint recognition module is configured to recognize the fingerprint collected by the fingerprint collection part, wherein the fingerprint recognition module is arranged in the accommodating space and the fingerprint collection part is arranged on the side.

According to the embodiments of the present disclosure, the fingerprint collection part is one of a fingerprint reader, a crystal sensor, or a camera.

According to the embodiments of the present disclosure, the fingerprint collection part is electrically connected to the fingerprint recognition module through a Flexible Printed Circuit (FPC).

According to the embodiments of the present disclosure, the terminal device further comprises: a key arranged on the side of the housing, wherein the fingerprint collection part is arranged on the key.

According to the embodiments of the present disclosure, the key is a volume key or a power key.

According to the embodiments of the present disclosure, the fingerprint collection part is directly embedded in the side.

According to the embodiments of the present disclosure, the fingerprint collection part comprises a collection surface oriented to the outside of the terminal device.

In an aspect, the embodiments of the present disclosure provide a terminal device, comprising: a display unit configured to display content; a fingerprint recognition unit capable of recognizing a fingerprint; and a processor connected to the display unit and the fingerprint recognition unit, wherein the fingerprint recognition unit is configured to acquire a first indication operation of an operator in a first direction by collecting a fingerprint of the operator when an identifier on the display unit is in a first position, and the processor is configured to control the identifier on the display unit to move from the first position to a second position in a first mapping direction, wherein the first mapping direction corresponds to the first direction.

According to the embodiments of the present disclosure, the processor is further configured to: generate and perform a first operation instruction based on the second position, after controlling the identifier on the display unit of the terminal device to move from the first position to the second position in the first mapping direction in response to the first indication operation.

According to the embodiments of the present disclosure, the terminal device further comprises: an acquisition unit configured to acquire a second operation of the operator after controlling the identifier on the display unit of the terminal device to move from the first position to the second position in the first mapping direction in response to the first indication operation; and wherein the processor is further configured to: generate and perform a second operation instruction related to the second position in response to the second operation.

According to the embodiments of the present disclosure, the fingerprint recognition unit is configured to: scan to acquire N images of the operator when it is detected a contact between the operator and the fingerprint recognition unit, wherein N is an integer larger than or equal to 2; and wherein the processor is further configured to: determine the first indication operation of the operator in the first direction based on the i^{th} image and the (i+1)^{th} image of the N images, wherein i is an integer from 1 to N−1.

According to the embodiments of the present disclosure, the terminal device further comprises: an image collection unit configured to collect an image; wherein when the image collection unit is in the process of image collection, the processor is configured to: control to place a focus of the image collection unit at the second position in response to the second operation; and generate and perform a focusing operation instruction to control the image collection unit to perform a focusing operation.

According to the embodiments of the present disclosure, the processor is further configured to: after generating and performing a focusing operation instruction to control the image collection unit to perform a focusing operation, acquire a third operation; and generate and perform an image collection instruction in response to the third operation to control the image collection unit to collect an image.

According to the embodiments of the present disclosure, the display unit has displayed thereon multiple icons respectively corresponding to multiple objects, where the first position is on an icon corresponding to a first object, and the second position is on an icon corresponding to a second object, and the processor is further configured to: select the second object after controlling the identifier to move from the first position to the second position in the first mapping direction in response to the first indication operation.

According to the embodiments of the present disclosure, the acquisition unit is configured to acquire a fourth operation of the operator; and the processor is further configured to generate and perform a fourth operation instruction for the second object in response to the fourth operation.

In another aspect, the embodiments of the present disclosure provide an information processing method, the method comprising: acquiring, by a fingerprint recognition unit of a terminal device, a first indication operation of an operator in a first direction by collecting a fingerprint of the operator when an identifier on a display unit of the terminal device is in a first position; and controlling the identifier on the display unit to move from the first position to a second position in a first mapping direction in response to the first indication operation, wherein the first mapping direction corresponds to the first direction.

According to the embodiments of the present disclosure, after controlling the identifier on the display unit of the terminal device to move from the first position to the second position in the first mapping direction in response to the first indication operation, the method further comprises: generating and performing a first operation instruction based on the second position.

According to the embodiments of the present disclosure, after controlling the identifier on the display unit of the terminal device to move from the first position to the second position in the first mapping direction in response to the first indication operation, the method further comprises: acquiring a second operation of the operator; and generating and performing a second operation instruction related to the second position in response to the second operation.

According to the embodiments of the present disclosure, the step of acquiring, by the fingerprint recognition unit, a first indication operation of an operator in a first direction by collecting a fingerprint of the operator when an identifier on the display unit is in a first position comprises: scanning to acquire N images of the operator when it is detected a contact between the operator and the fingerprint recognition unit, wherein N is an integer larger than or equal to 2; and determining the first indication operation of the operator in the first direction based on the i^{th} image and the (i+1)^{th} image of the N images, wherein i is an integer from 1 to N−1.

According to the embodiments of the present disclosure, the step of scanning to acquire N images of the operator when it is detected a contact between the operator and the fingerprint recognition unit comprises: acquiring at least one scanning message by scanning the operator; and generating N images based on the at least one scanning message.

According to the embodiments of the present disclosure, the terminal device further comprises an image collection unit, and when the image collection unit is in the process of image collection, the step of generating and performing a first operation instruction in response to the second operation comprises: controlling to place a focus of the image collection unit at the second position in response to the second operation; and generating and performing a focusing operation instruction to control the image collection unit to perform a focusing operation.

According to the embodiments of the present disclosure, after generating and performing a focusing operation instruction to control the image collection unit to perform a focusing operation, the method further comprises: acquiring a third operation; and generating and performing an image collection instruction in response to the third operation to control the image collection unit to collect an image.

According to the embodiments of the present disclosure, the display unit has displayed thereon multiple icons respectively corresponding to multiple objects, where the first position is on an icon corresponding to a first object, and the second position is on an icon corresponding to a second object, and the method further comprises: after controlling the identifier to move from the first position to the second position in the first mapping direction in response to the first indication operation, selecting the second object.

According to the embodiments of the present disclosure, after selecting the second object, the method further comprises: acquiring a fourth operation of the operator; and generating and performing a fourth operation instruction for the second object in response to the fourth operation.

### BRIEF DESCRIPTION OF THE DRAWINGS

FIG. 1 is a perspective diagram of a terminal device according to an embodiment of the present disclosure;

FIG. 2 is a perspective diagram of another terminal device according to an embodiment of the present disclosure;

FIG. 3 is a perspective diagram of another terminal device according to an embodiment of the present disclosure;

FIG. 4 is a perspective diagram of another terminal device according to an embodiment of the present disclosure;

FIG. 5 is a perspective diagram of another terminal device according to an embodiment of the present disclosure;

FIG. 6 is a diagram of an arrangement of a fingerprint collection part and a heart rate detection module on a terminal device according to an embodiment of the present disclosure;

FIG. 7 is a diagram of a heart rate detection module according to an embodiment of the present disclosure;

FIG. 8 is a flowchart of an information processing method according to an embodiment of the present disclosure;

FIGS. 9a and 9b are structural diagrams of a terminal device according to an embodiment of the present disclosure;

FIGS. 10a and 10b are diagrams of a fingerprint recognition unit according to an embodiment of the present disclosure;

FIGS. 11a and 11b are diagrams of a first image and a second image according to an embodiment of the present disclosure;

FIG. 12 is a diagram of a preview image and a focus frame according to the first embodiment and the second embodiment of the present disclosure;

FIG. 13 is a diagram of an operation being performed on an object according to the third embodiment of the present disclosure; and

FIG. 14 is a diagram of a terminal device according to an embodiment of the present disclosure.

### DETAILED DESCRIPTION

In order to further set forth the technical measures and effects used in the present disclosure for achieving intended purposes, the detailed description, structures, features and effects thereof of the present disclosure will be described in detail below in combination with accompanying drawing and preferable embodiments. In the following description, different references to “an embodiment” or “embodiment” do not necessarily refer to the same embodiment. In addition, particular features, structures, or characteristics in one or more embodiments can be combined in any suitable manner.

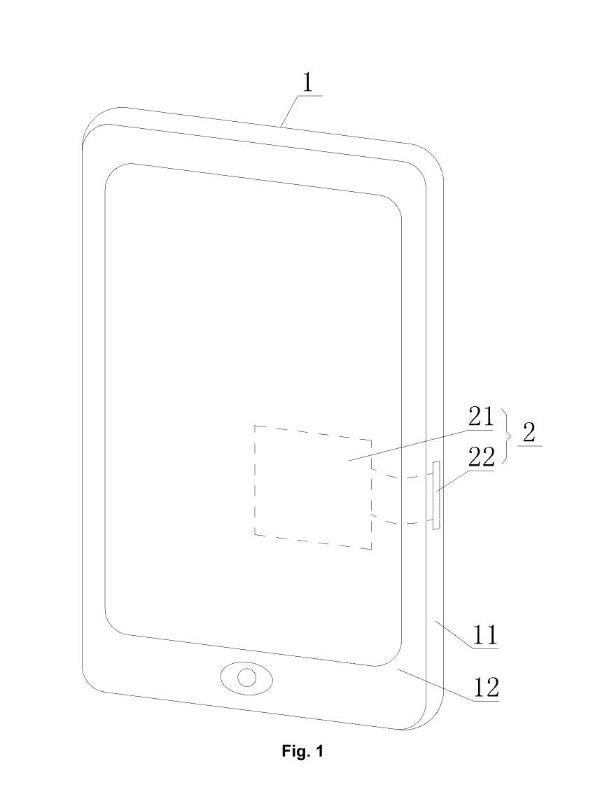

As shown in FIGS. 1-4, a terminal device according to an embodiment of the present disclosure comprises a housing 1 and a fingerprint recognition unit 2. The housing 1 has an accommodating space formed therein, and comprises a front surface 12, a rear surface (not shown), and a side 11 which connects the front surface 12 to the rear surface. The fingerprint recognition unit 2 comprises a fingerprint recognition module 21 and a fingerprint collection part 22.

The fingerprint recognition module 21 is connected to the fingerprint collection part 22 and arranged in the accommodating space. The fingerprint collection part 22 is arranged on the side 11 and is configured to collect a fingerprint. The fingerprint recognition module 21 is configured to recognize the fingerprint collected by the fingerprint collection part 22. Specifically, when a user's finger touches the fingerprint collection part 22, the fingerprint collection part 22 may collect fingerprint information of the user's finger, and the fingerprint recognition module 21 recognizes the user's identity according to the collected fingerprint information. The specific structure of the fingerprint recognition module 21 is common in the prior art, and may be selected as needed, which will not be described here.

As the function of fingerprint recognition is integrated on the terminal device through the fingerprint recognition module 21, compared to unlocking by using a digital password in the prior art, unlocking through fingerprint recognition has higher security. In addition, as the fingerprint collection part 22 is arranged on the side 11 of the housing 1, the requirements for implementing an operation with a single hand can be satisfied, thereby improving user experience.

Further, in the present embodiment, a display unit (not shown) may be arranged on the front surface of the housing, and may be a display screen or any part having a display function.

Further, in the present embodiment, the fingerprint collection part 22 may be one of a fingerprint reader, a crystal sensor, or a camera, to collect a user's fingerprint. Specifically, the fingerprint collection part 22 may be set according to practical requirements of the manufacturer of the terminal device.

Further, in order to facilitate a connection between the fingerprint collection part 22 and the fingerprint recognition module 21 and reduce an installation space, in the present embodiment, the fingerprint collection part 22 is electrically connected to the fingerprint recognition module 21 through a Flexible Printed Circuit (FPC). The FPC is a printed circuit board with highly reliable and excellent flexibleness which is made by using a polyimide or polyester film as a base material. The FPC has a wiring with a high density, a light weight, and a thin thickness. In the present embodiment, the fingerprint collection part 22 is electrically connected to the FPC and the fingerprint recognition module 21, which can largely save the installation space.

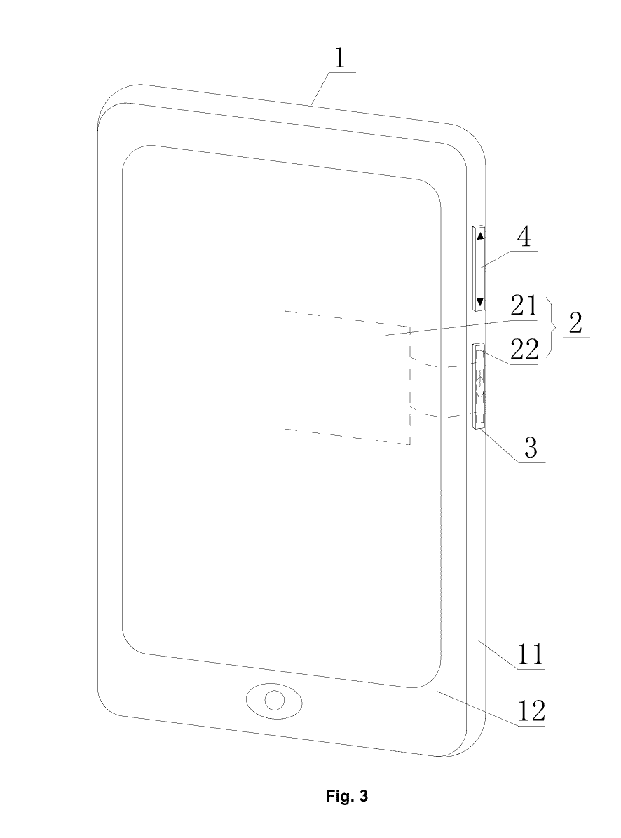

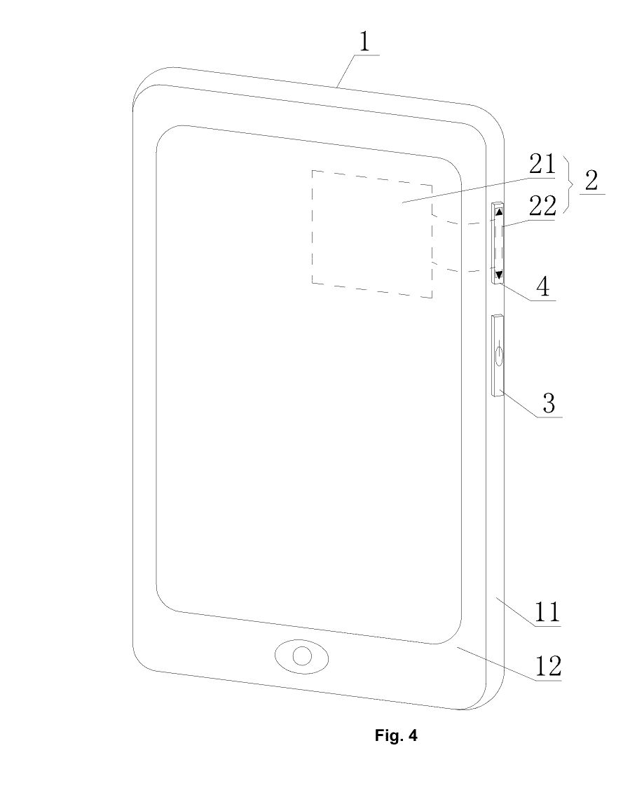

Further, as shown in FIGS. 3-4, the terminal device according to the embodiment of the present disclosure may further comprise a key arranged on the side 11 of the housing 1, and the fingerprint collection part 22 is arranged on the key. Specifically, the fingerprint collection part 22 may be embedded in the key or be affixed to an external surface of the key. A user may perform fingerprint recognition by pressing the key. In this way, the terminal device has a simple structure and is easy to be operated by a user.

Further, as shown in FIGS. 3 and 4, the e key may be a volume key 4 or a power key 3. Specifically, in the present embodiment, the terminal device per se has a volume key 4 or a power key 3, and the fingerprint collection part 22 is embedded in the volume key 4 or the power key 3 to save the installation space of the terminal device and extend the function of the volume key 4 or the power key 3. In this way, a user's fingerprint can be recognized while the user presses the volume key 4 or the power key 3, which is more suitable for user's habits and satisfies requirements for implementing an operation with a single hand.

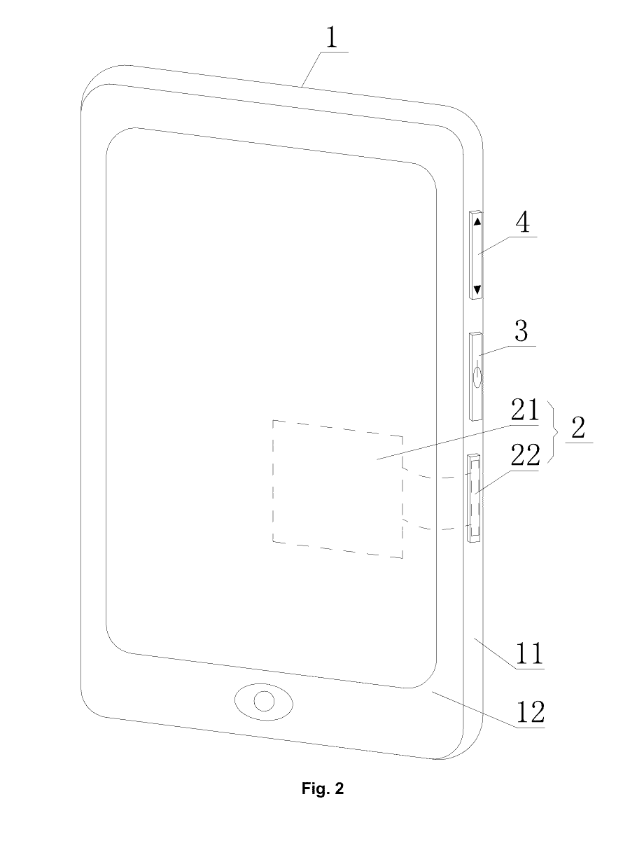

Further, in another embodiment of the present disclosure, as shown in FIGS. 1 and 2, regardless of whether a key is arranged on the side of the terminal device, the above fingerprint collection part 22 may be directly embedded in the side 11. In this way, the structure is simple and the cost is low. When the fingerprint collection part 22 which is arranged separately is triggered, the fingerprint collection part 22 collects a fingerprint and transmits the collected fingerprint to the fingerprint recognition module arranged in the accommodating space of the mobile terminal. In this way, the fingerprint recognition and the user's key-press operation are implemented separately.

Further, as shown in FIG. 1, the housing 1 of the terminal device may comprise four sides 11, which are an upper side, a lower side, a left side and a right side. The fingerprint collection part 22 may be directly embedded in any of the four sides 11, which may be set according to practical requirements.

Further, in another embodiment of the present disclosure, a key (for example, the volume key 4 or the power key 3 in FIGS. 3 and 4) may be arranged on any of the sides of the housing 1 of the mobile terminal, and correspondingly, the fingerprint collection part 22 is arranged on a corresponding key.

Further, the fingerprint collection part 22 may comprise a collection surface (not shown) which is orientated to the outside of the terminal device. When a user presses a finger on the collection surface, the user's fingerprint information may be rapidly collected via the collection surface.

Further, the terminal device may be a mobile phone, a tablet or the like, which may be set according to practical requirements.

The heart rate value is not only one of important medical indexes that reflect the degree of human health, but also is one of important bases for instructing people make good habits and instructing an athlete conduct scientific training. The heart rate value is generally defined as a number of human cardiac impulses within one minute. The commonly-used heart rate detection device is a stethophone. In the prior art, human heart rate information may also be collected through a finger. The specific principle thereof is that when the heart beats, a concentration of red blood cells in human blood vessels changes. Different concentrations of red blood cells have different reflectivity to the infrared ray. Thus, the difference in the concentrations of the red blood cells can be calculated through the infrared ray reflected by the finger, so as to calculate a heartbeat frequency.

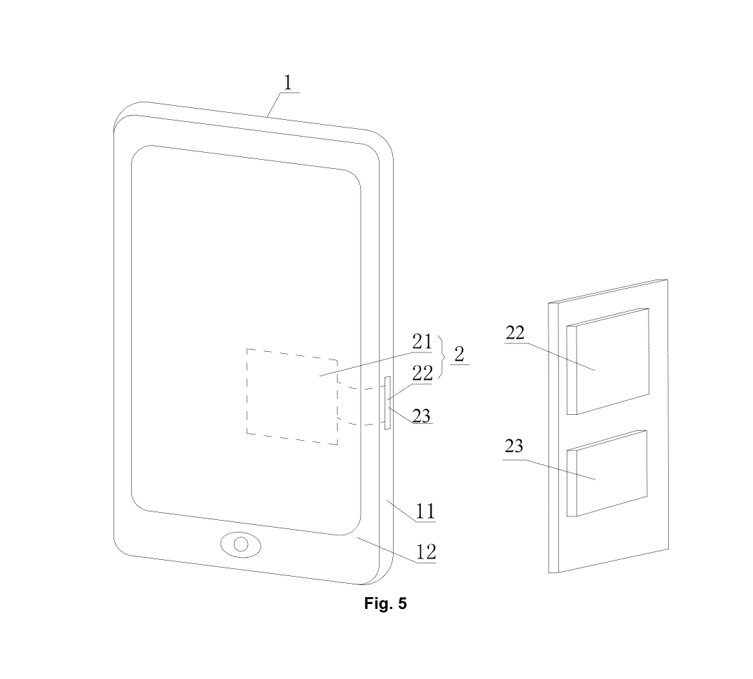

In an embodiment according to the present disclosure, as shown in FIG. 5, the terminal device may further comprise a heart rate detection module 23 which is arranged together with the fingerprint collection part 22. In this way, when a user's finger touches the fingerprint collection part 22, the fingerprint collection part 22 may collect the fingerprint of the user's finger, while the heat rate detection module 23 may detect the heart rate of the user through the user's finger. The housing of the terminal device can accommodate both the fingerprint collection part and the heart rate detection module by leaving one mounting location, which simplifies the structure of the housing and further improves the functional integration of the terminal device.

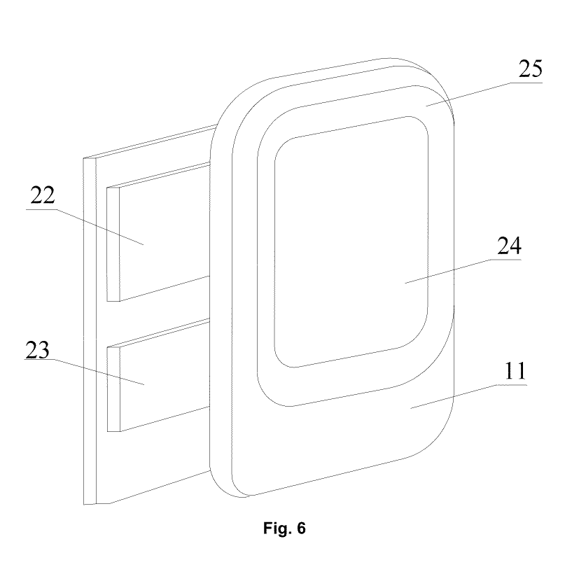

In an embodiment of the present disclosure, as shown in FIG. 6, the heart rate detection module 23 may be arranged beneath a finger contact surface 24 together with the fingerprint collection part 22. When the user's finger touches the finger contact surface 24, the fingerprint collection part 22 may collect the fingerprint of the user's finger through the finger contact surface 24 while the heart rate detection module 23 may detect heart rate information of the user through the finger contact surface 24.

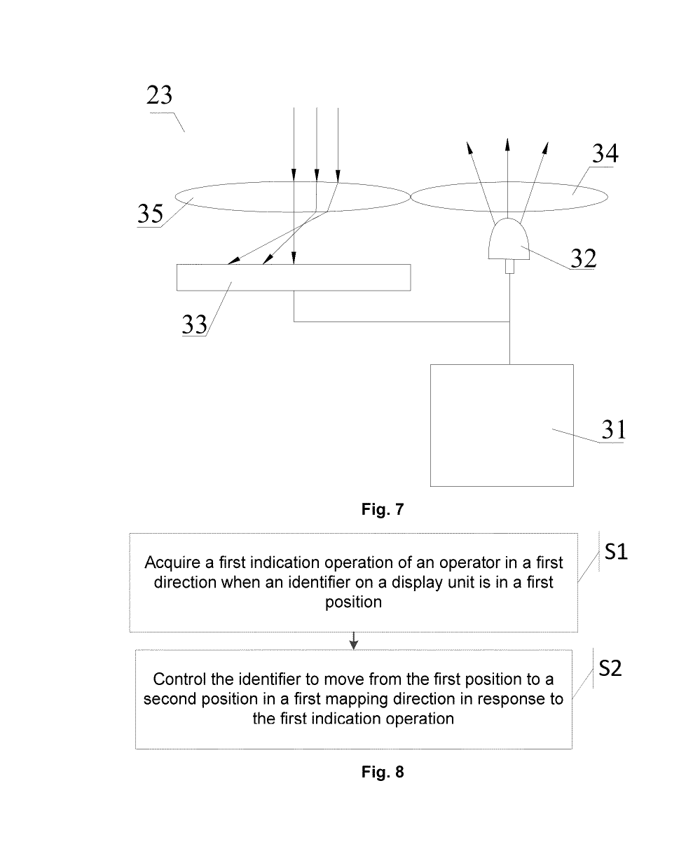

In order to achieve the function of the heart rate detection module 23, as shown in FIG. 7, the heart rate detection module 23 comprises a single chip 31, an infrared lamp 32 and an optical sensor 33. The single chip 31 is electrically connected to the infrared lamp 32 and the optical sensor 33 respectively. The infrared lamp 32 is configured to be driven to emit an infrared ray to the finger contact surface 24; and the optical sensor 33 is configured to receive the infrared ray reflected by the finger contact surface 24 and transmit a signal to the single chip 31. Specifically, when the user's finger touches the finger contact surface 24, the infrared lamp 32 is driven to emit an infrared ray, and the infrared ray is illuminated on the user's finger through the finger contact surface 24. A part of the infrared ray is reflected by the user's finger, and is illuminated on the optical sensor 33 through the finger contact surface. The optical sensor 33 receives the reflected infrared ray and transmits a signal to the single chip 31, which may calculate a human heartbeat frequency, i.e., the heart rate. The specific type of the single chip 31 may be selected as needed, which will not be described here.

Further, in order to improve the light utilization of the infrared lamp 32, as shown in FIG. 7, the heart rate detection module 23 according to an embodiment of the present disclosure may further comprise a first optical lens 34. The first optical lens 34 is arranged above the infrared lamp 32, and may uniformly diffuse the infrared ray emitted from the infrared lamp 32, so that the infrared ray passing through the first optical lens 34 can sufficiently contact the user's finger, thereby improving the light utilization of the infrared lamp 32.

Further, in order to enable all of the infrared ray reflected by the user's finger to be illuminated on the optical sensor 33, so as to improve the accuracy of the heart rate detection by the heart rate detection module 23, as shown in FIG. 7, the heart rate detection module 23 according to the embodiment of the present disclosure may further comprise a second optical lens 35 arranged above the optical sensor 33 and configured to converge the infrared ray reflected by the user's finger to the optical sensor 33, so that the optical sensor 33 collects more data, thereby improving the accuracy of the heart rate detection by the heart rate detection module 23.

Further, in order to ensure that the infrared ray can successfully pass through the finger contact surface 24, the finger contact surface 24 according to the embodiment of the present disclosure is a glass surface. Specifically, the housing 1 has a window (not shown) arranged thereon, where a glass is installed. The finger contact surface 24 is an upper surface of the glass. A transmittivity of an infrared ray through the glass may be more than 75%, which can satisfy design requirements.

Further, in order to enable the terminal device to be more aesthetic, an upper surface of the glass according to the embodiment of the present disclosure is coated with an ink layer (not shown). Of course, in other embodiments, the upper surface of the glass may be coated with another coating layer, which is not limited in the present embodiment, and may be set according to practical requirements.

Further, in order to position the user's finger when the user's finger touches the finger contact surface 24, as shown in FIG. 6, the finger contact surface 24 according to the embodiment of the present disclosure recesses inwardly on the side 11 of the housing 1 to form a groove structure 25. Specifically, the finger contact surface 24 is a plane, and has a protruding perimeter. Thus, the finger contact surface 24 recesses inwardly on the side 11 of the housing 1. When the user's finger presses on the finger contact surface 24, the groove structure 25 can be used to easily position the user's finger, so as to achieve rapid alignment and positioning of the user's finger. In this way, a condition that the user's finger derivates from a preset detection position when it touches the finger contact surface 24 is avoided, thereby improving the efficiency of the fingerprint recognition and heart rate detection.

Further, in order to protect the finger contact surface 24 to prevent the finger contact surface 24 from being subjected to an external damage, the finger contact surface 24 according to the embodiment of the present disclosure has a protection cover (not shown) arranged thereon. Specifically, the protection cover is snapped onto an upper surface of the finger contact surface 24. In use, the protection cover is detached from the housing 1, to expose the finger contact surface 24 therein. When the fingerprint collection part and the heart rate detection module according to the embodiment of the present disclosure are in an idle state, the protection cover is snapped onto the finger contact surface 24.

Further, the terminal device according to the embodiment of the present disclosure further comprises a storage (not shown), which is connected to the fingerprint recognition module 21 and the heart rate detection module 23 respectively. The storage may store user's fingerprint information and heart rate information, so that a user can easily view the information.

Further, the terminal device according to the embodiment of the present disclosure further comprises a communication interface (not shown) electrically connected to the storage. Data exchange with the storage may be implemented by a user through the communication interface, to facilitate a user to read related fingerprint information and heart rate information in the storage.

Further, in order to facilitate a user to timely view fingerprint information and heart rate information of his/her own, the terminal device according to the embodiment of the present disclosure further comprises a display unit (which is arranged on the front surface of the housing 1, for example), configured to display the fingerprint information and the heart rate information. Specifically, when the user's finger touches the finger contact surface 24, the fingerprint recognition module 21 recognizes the user's fingerprint information, and the heart rate detection module 23 detects the user's heart rate. In this case, the display unit can display in real time the user's fingerprint information and the heart rate information for view by the user, thereby improving user experience.

According to an embodiment of the present disclosure, an information processing method is further provided, in which the fingerprint recognition unit 2 according to the embodiment of the present disclosure may be used to facilitate a user to operate the terminal device 1 with a single hand.

As shown in FIG. 8, the embodiment of the present disclosure provides an information processing method, comprising:

S1: acquiring, by the fingerprint recognition unit 2, a first indication operation of an operator in a first direction by collecting a fingerprint of the operator when an identifier on a display unit is in a first position; and

S2: controlling the identifier on the display unit to move from the first position to a second position in a first mapping direction in response to the first indication operation, wherein the first mapping direction corresponds to the first direction.

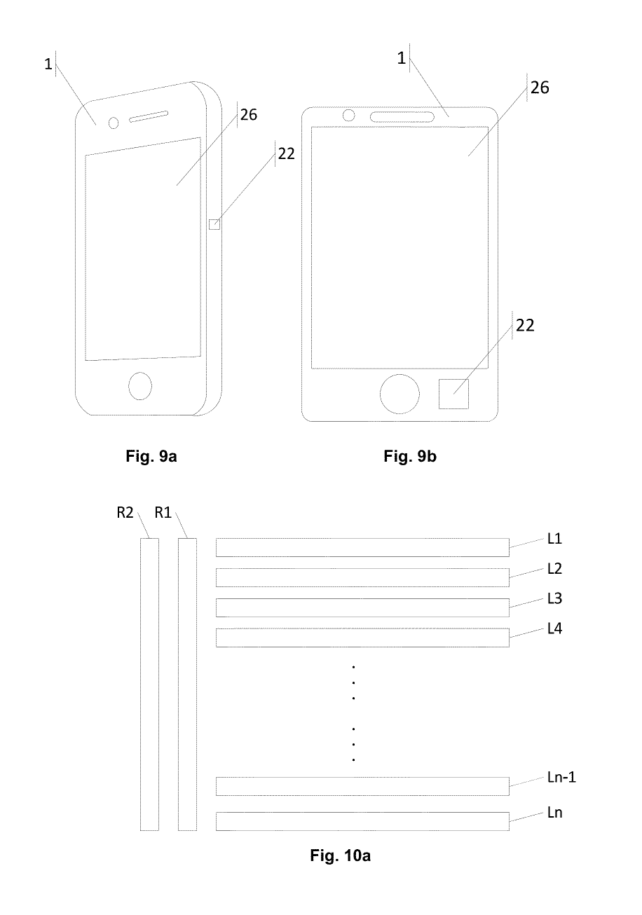

In order to solve the technical problem that it is inconvenient to use the terminal device with a single hand, the terminal device according to an embodiment of the present disclosure is arranged with a fingerprint recognition unit. The fingerprint recognition unit may be the above fingerprint recognition unit 2 comprising the fingerprint recognition module 21 and the fingerprint collection part 22. The fingerprint recognition module is arranged in an internal accommodating space in the terminal device, and the fingerprint collection part is arranged on the side of the terminal device. For example, the fingerprint collection part of the fingerprint recognition unit according to the embodiment of the present disclosure may be arranged on the right side or the left side of the terminal device, as shown in FIG. 9a.

According to another embodiment of the present disclosure, the fingerprint collection part 22 may be arranged on the same surface of the terminal device as the display unit, instead of being arranged on the side of the terminal device. For example, as shown in FIG. 9b, the fingerprint collection part 22 may be arranged on the surface of the main menu key which is in the middle and lower portion of the display unit 26, or is arranged individually on the right side of the main menu key or the like. Alternatively, in another embodiment of the present disclosure, the fingerprint collection part 22 may be arranged on an opposite surface to the display unit. Those skilled in the art can make a choice according to practical requirements, which is not limited in the present disclosure.

Steps S1 and S2 are described in detail below.

Specifically, an identifier on the display unit is used to indicate a position, region and/or instruction on the terminal device 1 which is controllable currently. In the embodiment of the present disclosure, the identifier may be an arrow, a vertical line, a square frame with a side of 0.5 cm or the like. In a specific implementation, those skilled in the art can make a choice according to practical requirements, which is not limited in the present disclosure.

Both the first position and the second position are located on a display region in the display unit. Further, in the embodiment of the present disclosure, the first position may further be located on a first object icon, and/or the second position may be located on a second object icon. For example, the first position is located on an icon of a “short message” application, and the second position is located on an icon of a “music” application, which is not limited in the present disclosure.

In the embodiment of the present disclosure, step S1 further comprises: (1) scanning, by the fingerprint recognition unit, the operator to acquire N images when the fingerprint recognition unit 2 detects a contact between the operator and the fingerprint recognition unit, wherein N is an integer larger than or equal to 2; and (2) determining the first indication operation of the operator in the first direction based on the i^{th} image and the (i+1)^{th} image of the N images, wherein i is an integer from 1 to N−1.

Alternatively, step (1) further comprises: scanning, by a scanning array in the fingerprint recognition unit, the operator, and transmitting the acquired at least one scanning message to a receiving array in the fingerprint recognition unit; and generating, by the receiving array, the N images based on the at least one scanning message.

Firstly, in the embodiment of the present disclosure, the fingerprint recognition unit may be a capacitive fingerprint recognition unit, a photoelectric fingerprint recognition unit, or an ultrasonic fingerprint recognition unit or the like, which is not limited in the present disclosure.

In a specific implementation, step (1) further comprises: scanning, by a first unit in the fingerprint recognition unit, the operator, and transmitting the acquired at least one scanning message to a second unit in the fingerprint recognition unit; and receiving, by the second unit, the at least one scanning message, and generating the N images based on the at least one scanning message.

As in a specific implementation, the fingerprint recognition unit may comprise different fingerprint arrays based on different biological principles, the specific implantations of step (1) may be different. The present disclosure will be described in detail by taking a capacitive fingerprint recognition unit as an example below.

FIG. 10a is a diagram of a fingerprint collection part of a fingerprint recognition unit according to an embodiment of the present disclosure. In the case that the fingerprint recognition unit is specifically a capacitive fingerprint recognition unit, the first unit is specifically a transmitting array of the fingerprint recognition unit. The transmitting array L1, L2, . . . , Ln transmits an electromagnetic wave at a certain frequency, such as 20 MHz, 20.1 MHz or the like, so as to scan a finger which contacts the fingerprint recognition unit (for example, the finger contact surface 24) many times. The second unit is specifically a receiving array R1, R2 of the fingerprint recognition unit, which receives the electromagnetic wave transmitted by the transmitting array L1, L2, . . . , Ln, and recognizes the fingerprint information according to the quantity of electric charge or current of the received electromagnetic wave, i.e., at least one scanning message. In the embodiment of the present disclosure, the number of transmitting strips in the transmitting array may be up to 70, 80 or the like. In order to determine the possibility of the finger to move to the left or the right, there need at least two receiving arrays, for example, 2, 4 or the like are needed. In the specific implementation, those skilled in the art can make a choice according to practical requirements, which is not limited in the present disclosure.

Further, in a specific implementation, the receiving arrays and the transmitting arrays may be arranged in the same plane, as shown in FIG. 10a, and the receiving arrays are arranged besides the transmitting arrays. Alternatively, the receiving arrays may also be arranged in a first layer, and the transmitting arrays may be arranged in a layer above the receiving arrays, as shown in FIG. 10b. Those skilled in the art can make a choice according to practical requirements, which is not limited in the present disclosure.

As a human body carries some charges, and each of transmitting strips in the transmitting array according to the embodiment of the present disclosure also carries charges, when the user's finger touches the transmitting array, there will be capacitance formed between the finger and the transmitting array. In addition, due to fissures and curved routes of the fingerprint, capacitance values formed between different parts of the fingerprint and the transmitting array are different. Therefore, after an electromagnetic wave transmitted by the transmitting array is subjected to different capacitance, the current changes differently.

Finally, after the receiving array receives the changed electromagnetic wave, currents of electromagnetic waves transmitted by various transmitting strips may be completely different. The current information is the at least one scanning message. After recognition and calculation are performed by the fingerprint recognition module, an image is acquired, which comprises the fingerprint information of the user's finger.

After the transmitting array transmits N electromagnetic waves, the receiving array may acquire N images, wherein N is an integer larger than or equal to 2.

Then, after N images are acquired in step (1), a first indication operation of the operator in a first direction is determined based on the i^{th} image and the (i+1)^{th} image of the N images.

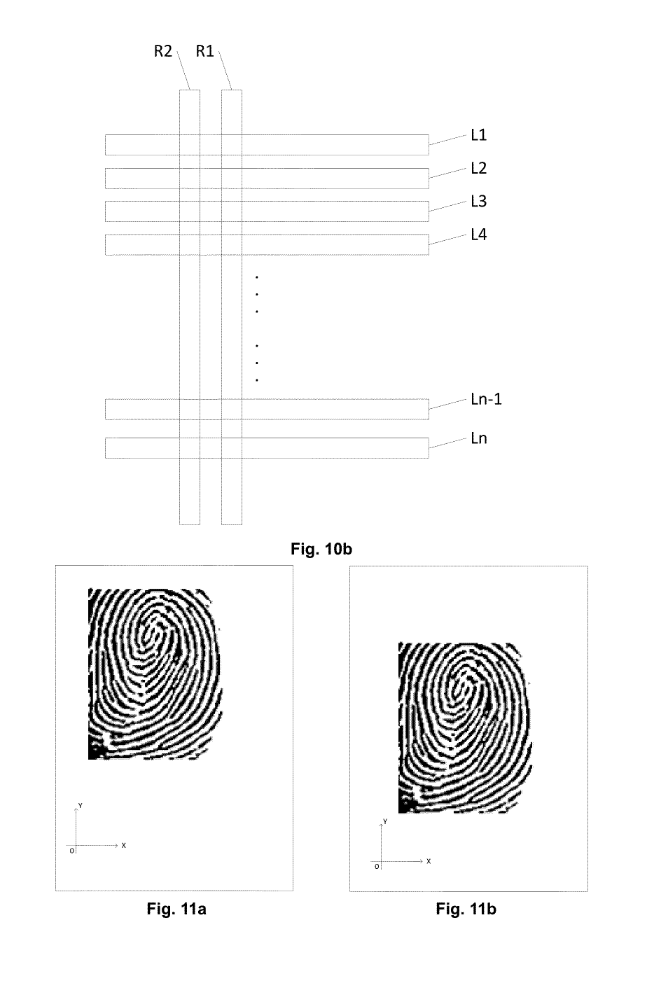

Specifically, i is an integer between 1 and N−1. For the sake of illustrating how to determine the first indication operation based on the i^{th} image and the (i+1)^{th} image, the present disclosure will be described below by assuming that a first image is as shown in FIG. 11a and a second image is as shown in FIG. 11b.

After acquiring the first image and the second image, the fingerprint recognition unit compares the first image with the second image. In the embodiment of the present disclosure, by comparing a second image of a fingerprint with a first image of the same fingerprint, it can be found that the fingerprint moves in a first direction, i.e., the direction of the y axis as shown in FIGS. 11a and 11b, towards the negative direction of the y axis. Then, it can be determined that the first indication operation of the user is an operation of moving an identifier in a mapping direction of the negative direction of the y axis.

After the first indication operation is determined, step S2 is performed. In step S2, the identifier on the display unit is controlled to move from the first position to a second position in a first mapping direction in response to the first indication operation, wherein the first mapping direction corresponds to the first direction.

Specifically, a mapping relationship between the first direction and the first mapping direction may be determined according to the position of the fingerprint collection part of the fingerprint recognition unit. Assuming that the fingerprint collection part of the fingerprint recognition unit and the display unit are arranged on the same surface of the terminal device, when the user's finger slides on the fingerprint collection part up and down, i.e., the first direction is parallel to the left and right sides, the first mapping direction is also parallel to the left and right sides; and assuming that the fingerprint collection part is arranged on the right side of the housing of the terminal device, when the user's finger slides on the fingerprint collection part up and down, the first mapping direction may be a direction parallel to the right side, and when the user's finger slides on the fingerprint collection part right and left, the first mapping direction may be a direction perpendicular to the right side. Those skilled in the art can make a choice according to practical requirements, which is not limited in the present disclosure.

Further, the second position may also be determined according to the mapping relationship. Specifically, it is assumed that the mapping relationship is that if the user's finger moves 0.1 cm on the fingerprint collection part, the identifier moves 1 cm on the display unit. By taking the above relationship between the first direction and the first mapping direction as an example, when the fingerprint collection part is arranged on the right side of the housing, assuming that the coordinates of the first position are (1 cm, 1 cm) and the user's finger moves 0.2 cm in the first direction, the coordinates of the second position are (3 cm, 1 cm). Those skilled in the art can select the mapping relationship according to practical requirements, which is not limited in the present disclosure.

Through the above process, the terminal device can acquire the first indication operation via the fingerprint recognition unit when a user operates the terminal device with a single hand by the user implementing a movement operation with a finger on the fingerprint recognition unit (specifically, the fingerprint collection part). Then, the identifier on the display unit moves to a second position intended for the user. Therefore, even if the user holds the terminal device in a single hand, the terminal device can be operated conveniently.

Alternatively, after step S1 in the embodiment of the present disclosure, it further comprises a step of generating and performing a first operation instruction based on the second position.

Specifically, after the identifier on the display unit moves to a second position, the terminal device may directly generate and perform the first operation instruction based on the second position. For example, after the identifier moves to an “exit” option, the terminal device may automatically generate and perform an instruction to exit the current interface; or when the terminal device is in a pre-photographing process, after the identifier moves to the second position, the terminal device may automatically generate and perform a focusing instruction, so that the terminal device has a focus located in the second position, or the like. Those skilled in the art can select the first operation instruction according to practical requirements, which is not limited in the present disclosure.

In addition, after step S1 in the embodiment of the present disclosure, it further comprises a step of acquiring a second operation of the operator; and a step of generating and performing a second operation instruction related to the second position in response to the second operation.

Specifically, after the identifier moves to the second position, the terminal may acquire the user's second operation. In the embodiment of the present disclosure, the second operation may be acquired in many manners. For example, the second operation performed by the user's finger on the fingerprint recognition unit may be acquired by the fingerprint recognition unit, or may be acquired by the display unit which is a touch display screen, or may be acquired by a key on the terminal device such as a power key, a main menu key or the like, which is not limited in the present disclosure.

The present disclosure will be described below by taking the case where the second operation is acquired by the touch display screen as an example. The second operation may be a single-click operation, a double-click operation or the like. The terminal device generates and performs the second operation instruction based on the user's second operation and the second position.

For example, after the identifier moves to the “exit” option, the touch display screen collects and acquires the user's single-click operation in any position on the touch display screen, and the terminal device generates and performs an instruction to exit the current interface; or when the terminal device is in a pre-photographing process, after the identifier moves to the second position, the touch display screen collects and acquires the user's long press touch in a preset region (such as a rectangular region with a width of 0.5 cm on the rightmost of the touch display screen), so that the terminal device has a focus located in the second position, or the like. Those skilled in the art can select the second operation instruction according to practical requirements, which is not limited in the present disclosure.

Preferably, in the embodiment of the present disclosure, the second operation is acquired by the fingerprint recognition unit. The second operation may be a single-click operation, a double-click operation, a long press operation or the like. The terminal device generates and performs a second operation instruction based on the user's second operation and the second position.

For example, after the identifier moves to the “exit” option, the fingerprint recognition unit further acquires the user's single-click operation, and the terminal device generates and performs an instruction to exit the current interface; or when the terminal device is in a pre-photographing process, after the identifier moves to the second position, the fingerprint recognition unit further acquires a single-click operation, and the terminal device generates and performs a focusing instruction, so that the terminal device has a focus located in the second position, or the like. Those skilled in the art can select the second operation instruction according to practical requirements, which is not limited in the present disclosure. The present disclosure will be described below by several application examples in combination with the above technical solutions. In a specific implementation, the present disclosure comprises, but is not limited to, the following several examples.

### First Embodiment

The embodiment of the present disclosure provides a method for taking a picture with a single hand.

Assume that the image collection unit of the terminal device is in an acquisition process. In the acquisition process, a user views a preview image through the display unit of the terminal device. If a focus in the preview image does not satisfy user requirements, the user may manually adjust a position of a focus frame to perform a focusing operation again.

In the embodiment of the present disclosure, step S2 further comprises the following steps: controlling to place a focus of the image collection unit at the second position; and generating and performing a focusing operation instruction to control the image collection unit to perform a focusing operation.

Further, after step S2, it further comprises a step of acquiring a second operation of the operator; and a step of generating and performing an image collection instruction to control the image collection unit to collect an image.

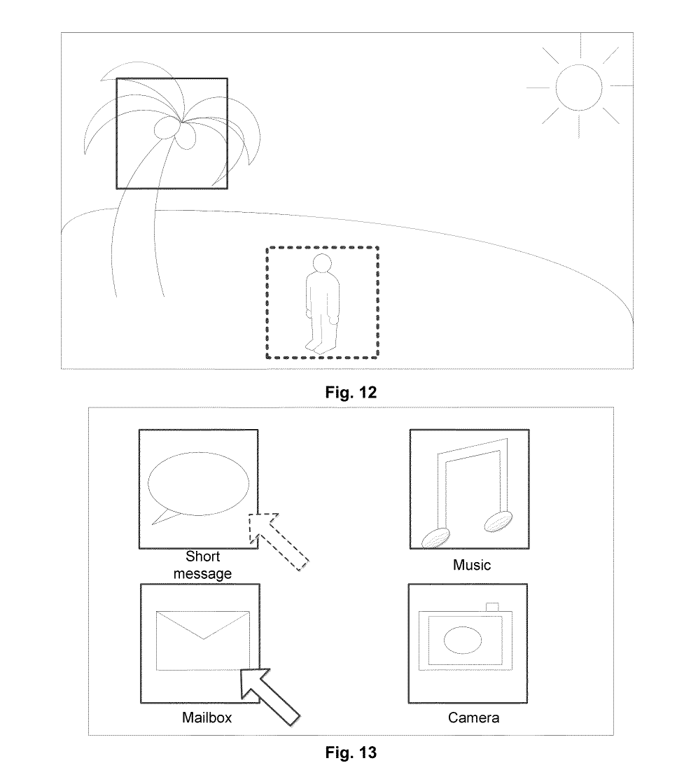

Specifically, as shown in FIG. 12, the identifier is a focus frame, and it is assumed that in the preview image, the image collection unit performs a focusing operation based on the first position, i.e., the position where the dashed frame is located in FIG. 12. However, the user wants to control to place the focus at the coconut tree, and in this case, the user puts his/her finger on the fingerprint recognition unit (specifically, the fingerprint collection part) and moves the finger in the first direction. The terminal device detects a first indication operation of the user's finger in the first direction, and controls the focus frame to move in a first mapping direction, i.e., a direction from the dashed frame to the solid frame in FIG. 12, to move the focus frame to the second position where the solid frame is located.

Then, the terminal device automatically generates a focusing instruction to control the image collection unit to perform a focusing operation based on the second position.

In the embodiment of the present disclosure, it is assumed that the terminal device acquires a second operation through the fingerprint recognition unit. After a focusing operation is performed based on the second position, when the user views a satisfactory image through the display unit, the user performs the second operation. Further, it is assumed that the second operation is to contact the fingerprint recognition unit once or twice within a preset time. In the embodiment of the present disclosure, the preset time may be 1 second, 0.8 second or the like, which is not limited in the present disclosure. If the fingerprint recognition unit detects that the user's finger touches the fingerprint recognition unit once or twice within the preset time, the image acquisition unit will be controlled to acquire an image.

With the above description, even if a user holds a mobile phone in a single hand to take a picture, the picture can be conveniently taken with a single hand by touching the fingerprint recognition unit and moving on the fingerprint recognition unit.

### Second Embodiment

The second embodiment of the present disclosure provides a method for taking a picture with a single hand. The same contents in the second embodiment as those in the first embodiment will not be described, and the difference between the second embodiment and the first embodiment is that the focusing operation will not be automatically performed after the focus frame arrives at the second position. When the image collection unit is in the acquisition process, the user controls the image collection unit to perform a focusing operation through a second operation, and the terminal device correspondingly performs the following steps: controlling to place the focus of the image collection unit to at the second position in response to the click operation; and generating and performing a focusing operation instruction to control the image collection unit to perform a focusing operation.

Alternatively, after the image collection unit is controlled to perform a focusing operation, it further comprises the following steps: acquiring a third operation; and generating and performing an image collection instruction in response to the third operation to control the image collection unit to collect an image.

Specifically, for the sake of illustration, the present disclosure will be described by taking the first operation being that the user's finger contacts the fingerprint recognition unit once within a preset time and the second operation being that the user's finger contacts the fingerprint recognition unit twice within a preset time as an example. If the user only contacts the fingerprint recognition unit once within the preset time, the image collection unit will perform a focusing operation based on the second position. After the focusing operation is performed, when the user views a satisfactory image through the display unit, the user contacts the fingerprint recognition unit twice within the preset time to control the image collection unit to acquire an image.

### Third Embodiment

With the technical solutions of the present disclosure, the object may further be operated.

The display unit has displayed thereon multiple icons respectively corresponding to multiple objects, where the first position is on an icon corresponding to a first object, and the second position is on an icon corresponding to a second object.

After controlling the identifier to move from the first position to the second position in the first mapping direction in response to the first indication operation, the method further comprises: selecting the second object.

Further, after selecting the second object, the method further comprises: acquiring a fourth operation of the operator; and generating and performing a fourth operation instruction for the second object in response to the fourth operation.

Specifically, it is assumed that the display unit has multiple objects displayed thereon. As shown in FIG. 13, four applications are displayed, which comprise “short message”, “music”, “mailbox” and “camera” respectively.

Firstly, the identifier is an arrow in FIG. 13, the solid arrow represents the second position of the identifier, and the dashed arrow represents the first position. The first position is located on an icon of the first object such as “short message”. In this case, if the user wants to open the mailbox to view a mail, the user moves on the fingerprint recognition unit to control the arrow to move to the second position. In the embodiment of the present disclosure, in the movement process, the arrow is located among the multiple objects.

After the arrow moves, if the user's finger and the fingerprint recognition unit are in a non-contact state, the movement is completed. In this case, the arrow moves to the second position, and specifically the arrow is located in the second position, i.e., on the “mailbox” icon, and the terminal device selects the “mailbox” object.

After the object is selected, the terminal device may operate the selected object. Then, the user's finger touches the fingerprint recognition unit again, so that the fingerprint recognition unit acquires a fourth operation.

Specifically, the fourth operation may be a single-click operation, a dual-click operation, a long-press operation or the like, which is not limited in the present disclosure. After the fourth operation is acquired, the terminal device generates and performs a fourth operation instruction for the second object in response to the fourth operation.

Specifically, there may be many kinds of fourth operation instructions, which comprise a start-up instruction, an icon hiding instruction, an uninstall instruction or the like. Those skilled in the art can make a choice according to practical requirements, which is not limited in the present disclosure.

Further, in a specific implementation, different fourth operation instructions may be generated according to respective fourth operations. For example, when the fourth operation is a single-click operation, the fourth operation instruction is an icon moving instruction; when the fourth operation is a dual-click operation, the fourth operation instruction is a second object start-up instruction; and when the fourth operation is a long-press operation, the fourth operation instruction is an application uninstall instruction. Those skilled in the art can make a choice according to practical requirements, which is not limited in the present disclosure.

It is assumed in the embodiment of the present disclosure that if after the second object is selected, the user performs a dual-click operation on the fingerprint recognition unit and the fourth operation instruction generated by the terminal device is a start-up instruction, the “mail” object is opened.

Of course, in the embodiment of the present disclosure, the fourth operation may further be acquired through the display unit which is a touch display screen, a key or the like.

For example, after the second object is selected, the user performs a single-click operation in any position of the touch display screen. The terminal device generates and performs a start-up instruction in response to the user's single-click operation to start the second object.

Alternatively, after the second object is selected, the user clicks on a volume up key, and then the terminal device generates a moving instruction to move the position where the second object is displayed a unit of distance upward or the like.

Those skilled in the art can select the fourth operation and the manner of acquiring the fourth operation according to practical requirements, which is not limited in the present disclosure.

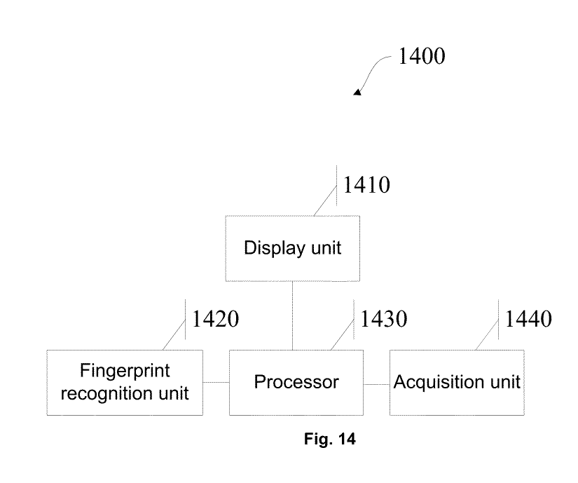

According to an embodiment of the present disclosure, a terminal device 1400 is provided, as shown in FIGS. 9a, 9b and 14. The terminal device 1400 according to the embodiment of the present disclosure comprises a display unit 1410 configured to display content; a fingerprint recognition unit 1420 capable of recognizing a fingerprint; and a processor 1430 connected to the display unit 1410 and the fingerprint recognition unit 1420. When an identifier on the display unit 1410 is in a first position, the fingerprint recognition unit 1420 acquires a first indication operation of an operator in a first direction by collecting a fingerprint of the operator, and in this case, the processor 1430 controls the identifier on the display unit 1410 to move from the first position to a second position in a first mapping direction, wherein the first mapping direction corresponds to the first direction.

The fingerprint recognition unit 1420 may comprise a fingerprint recognition module and a fingerprint collection part, wherein the fingerprint recognition module is connected to the fingerprint collection part, the fingerprint collection part is configured to collect a fingerprint, and the fingerprint recognition module is configured to recognize the fingerprint collected by the fingerprint collection part. The fingerprint recognition module is arranged in an internal accommodating space in the terminal device and the fingerprint collection part is arranged on a surface of the terminal device. The fingerprint recognition unit 1420 may be the above fingerprint recognition unit 2, which comprises the fingerprint collection part arranged on the side of the terminal device. As described above, the fingerprint collection part may be arranged on the same surface as the display unit 1410.

The processor 1430 is further configured to: generate and perform a first operation instruction based on the second position, after controlling the identifier on the display unit 1410 of the terminal device to move from the first position to the second position in the first mapping direction in response to the first indication operation.

Specifically, in the embodiment of the present disclosure, the fingerprint recognition unit 1420 is further configured to: scan to acquire N images of the operator when the fingerprint recognition unit 1420 detects a contact between the operator and the fingerprint recognition unit, wherein N is an integer larger than or equal to 2.

In the embodiment of the present disclosure, the processor 1430 is further configured to: determine the first indication operation of the operator in the first direction based on the i^{th} image and the (i+1)^{th} image of the N images, wherein i is an integer from 1 to N−1.

Further, the fingerprint recognition unit 1420 may further comprise: a first unit configured to scan the operator, and transmit the acquired at least one scanning message to a second unit in the fingerprint recognition unit; and the second unit configured to receive the at least one scanning message, and generate the N images based on the at least one scanning message.

In addition, in the embodiment of the present disclosure, the terminal device 1400 may further comprise: an acquisition unit 1440 configured to acquire a second operation of the operator after controlling the identifier on the display unit of the terminal device to move from the first position to the second position in the first mapping direction in response to the first indication operation.

The processor 1430 may be further configured to: generate and perform a second operation instruction related to the second position in response to the second operation.

For example, the terminal device may further comprise an image processing unit (not shown), and when the image collection unit is in an image collection process, the processor 1430 is further configured to: control to place a focus of the image collection unit at the second position in response to the second operation; and generate and perform a focusing operation instruction to control the image collection unit to perform a focusing operation.

The processor 1430 is further configured to: acquire a third operation after generating and performing a focusing operation instruction to control the image collection unit to perform a focusing operation; and generate and perform an image collection instruction in response to the third operation to control the image collection unit to collect an image.

Alternatively, when the display unit has displayed thereon multiple icons respectively corresponding to multiple objects, where the first position is on an icon corresponding to a first object, and the second position is on an icon corresponding to a second object, the processor 1430 may further be configured to: select the second object after controlling the identifier to move from the first position to the second position in the first mapping direction in response to the first indication operation.

Further, the acquisition unit 1440 is configured to: acquire a fourth operation of the operator.

The processor 1430 is further configured to: generate and perform a fourth operation instruction for the second object in response to the fourth operation.

One or more technical solutions as described in the embodiments of the present disclosure at least have the following one or more technical effects.

In the technical solutions of the present disclosure, the fingerprint collection part of the fingerprint recognition unit is arranged on the side of the terminal device. When a user holds the terminal device in his/her hand, the user's finger may touch the fingerprint collection part, and the fingerprint recognition module collects fingerprint information of the user's finger through the fingerprint collection part, and when the fingerprint information is validated, the terminal device can be unlocked. As the function of fingerprint recognition is integrated on the terminal device, compared to unlocking by using a digital password in the prior art, unlocking through fingerprint recognition has higher security. In addition, as the fingerprint collection part is arranged on the side of the housing, the requirements for implementing an operation with a single hand can be satisfied, thereby improving user experience.

In the technical solutions of the present disclosure, the fingerprint recognition unit arranged on the terminal device acquires a user's operation on the terminal device by acquiring user's control of the identifier on the display unit. Then, the technical effect of facilitating the user to operate the terminal device with a single hand can be achieved by the user implementing an operation on the fingerprint recognition unit without clicking on a corresponding place or key on the screen of the terminal device with a finger.

The above are merely preferable embodiments of the present disclosure, instead of limiting the present disclosure. Obviously, those skilled in the art can make various modifications and variations to the present disclosure without departing from the spirit and scope of the present disclosure. Thus, if these modifications and variations of the present disclosure fall in the scope of the claims of the present disclosure and the equivalent technologies thereof, the present disclosure is also intended to include these modifications and variations.

I/We claim:

1. A terminal device, comprising: a housing having an accommodating space formed therein, the housing comprising a front surface, a rear surface, and a side which connects the front surface to the rear surface, wherein the terminal device further comprises a fingerprint recognition unit, the fingerprint recognition unit comprising:
a fingerprint recognition module and a fingerprint collection part, wherein the fingerprint recognition module is connected to the fingerprint collection part, the fingerprint collection part is configured to collect a fingerprint, and the fingerprint recognition module is configured to recognize the fingerprint collected by the fingerprint collection part, and
wherein the fingerprint recognition module is arranged in the accommodating space and the fingerprint collection part is arranged on the side.

2. The terminal device according to claim 1, wherein the fingerprint collection part is electrically connected to the fingerprint recognition module through a Flexible Printed Circuit (FPC).

3. The terminal device according to claim 1, further comprising: a key arranged on the side of the housing, and wherein the fingerprint collection part is arranged on the key.

4. The terminal device according to claim 1, wherein the fingerprint collection part is directly embedded in the side.

5. The terminal device according to claim 1, wherein the fingerprint collection part comprises a collection surface oriented to the outside of the terminal device.

6. A terminal device, comprising:
a display unit configured to display content;
a fingerprint recognition unit capable of recognizing a fingerprint; and
a processor connected to the display unit and the fingerprint recognition unit,
wherein the fingerprint recognition unit is configured to acquire a first indication operation of an operator in a first direction by collecting a fingerprint of the operator when an identifier on the display unit is in a first position, and the processor is configured to control the identifier on the display unit to move from the first position to a second position in a first mapping direction, wherein the first mapping direction corresponds to the first direction.

7. The terminal device according to claim 6, wherein the processor is further configured to:
generate and perform a first operation instruction based on the second position, after controlling the identifier on the display unit of the terminal device to move from the first position to the second position in the first mapping direction in response to the first indication operation.

8. The terminal device according to claim 6, further comprising:
an acquisition unit configured to acquire a second operation of the operator after controlling the identifier on the display unit of the terminal device to move from the first position to the second position in the first mapping direction in response to the first indication operation; and
wherein the processor is further configured to:
generate and perform a second operation instruction related to the second position in response to the second operation.

9. The terminal device according to claim 6, wherein the fingerprint recognition unit is configured to:
scan to acquire N images of the operator when it is detected a contact between the operator and the fingerprint recognition unit, wherein N is an integer larger than or equal to 2; and
wherein the processor is further configured to:
determine the first indication operation of the operator in the first direction based on the i^{th} image and the (i+1)^{th} image of the N images, wherein i is an integer from 1 to N−1.

10. The terminal device according to claim 8, further comprising:
an image collection unit configured to collect an image; and
wherein when the image collection unit is in the process of image collection, the processor is configured to:
control to place a focus of the image collection unit at the second position in response to the second operation; and
generate and perform a focusing operation instruction to control the image collection unit to perform a focusing operation.

11. The terminal device according to claim 6, wherein the display unit has displayed thereon multiple icons respectively corresponding to multiple objects, where the first position is on an icon corresponding to a first object, and the second position is on an icon corresponding to a second object, and wherein the processor is further configured to:
select the second object after controlling the identifier to move from the first position to the second position in the first mapping direction in response to the first indication operation.

12. An information processing method, comprising:
acquiring, by a fingerprint recognition unit of a terminal device, a first indication operation of an operator in a first direction by collecting a fingerprint of the operator when an identifier on a display unit of the terminal device is in a first position; and
controlling the identifier on the display unit to move from the first position to a second position in a first mapping direction in response to the first indication operation, wherein the first mapping direction corresponds to the first direction.

13. The method according to claim 12, further comprising: after controlling the identifier on the display unit of the terminal device to move from the first position to the second position in the first mapping direction in response to the first indication operation,
generating and performing a first operation instruction based on the second position.

14. The method according to claim 12, further comprising: after controlling the identifier on the display unit of the terminal device to move from the first position to the second position in the first mapping direction in response to the first indication operation,
acquiring a second operation of the operator; and
generating and performing a second operation instruction related to the second position in response to the second operation.

15. The method according to claim 12, wherein the step of acquiring, by the fingerprint recognition unit, a first indication operation of an operator in a first direction by collecting a fingerprint of the operator when an identifier on the display unit is in a first position comprises:
scanning to acquire N images of the operator when it is detected a contact between the operator and the fingerprint recognition unit, wherein N is an integer larger than or equal to 2; and
determining the first indication operation of the operator in the first direction based on the i^{th} image and the (i+1)^{th} image of the N images, wherein i is an integer from 1 to N−1.

16. The method according to claim 15, wherein the step of scanning to acquire N images of the operator when it is detected a contact between the operator and the fingerprint recognition unit comprises:
acquiring at least one scanning message by scanning the operator; and
generating N images based on the at least one scanning message.

17. The method according to claim 14, wherein the terminal device further comprises an image collection unit, and when the image collection unit is in the process of image collection, the step of generating and performing a first operation instruction in response to the second operation comprises:
controlling to place a focus of the image collection unit at the second position in response to the second operation; and
generating and performing a focusing operation instruction to control the image collection unit to perform a focusing operation.

18. The method according to claim 17, further comprising: after generating and performing a focusing operation instruction to control the image collection unit to perform a focusing operation,
acquiring a third operation; and
generating and performing an image collection instruction in response to the third operation to control the image collection unit to collect an image.

19. The method according to claim 12, wherein the display unit has displayed thereon multiple icons respectively corresponding to multiple objects, where the first position is on an icon corresponding to a first object, and the second position is on an icon corresponding to a second object, and the method further comprises: after controlling the identifier to move from the first position to the second position in the first mapping direction in response to the first indication operation,
selecting the second object.

20. The method according to claim 19, further comprising: after selecting the second object,
acquiring a fourth operation of the operator; and
generating and performing a fourth operation instruction for the second object in response to the fourth operation.
